(19) United States
(12) Patent Application Publication
(10) Pub. No.: US 2026/0339780 A1
(43) Pub. Date: Oct. 29, 2026

(54) N-READ ERROR CHECK SCRUB SYSTEMS AND METHODS

(71) Applicant: Micron Technology, Inc., Boise, ID (US)

(72) Inventors: Wesley W. Borie, Boise, ID (US); Dennis G. Montierth, Meridian, ID (US); Garth N. Grubb, Boise, ID (US); Michael Schena, Boise, ID (US); Matthew Oatman, Boise, ID (US)

(21) Appl. No.: 19/459,755

(22) Filed: Jan. 26, 2026

Related U.S. Application Data
(60) Provisional application No. 63/793,994, filed on Apr. 24, 2025.

(51) Int. Cl. G06F 11/10

(52) U.S. Cl. CPC G06F 11/106; G06F 11/1016

(57) ABSTRACT

Systems and methods include a memory device that includes circuitry. The circuitry may be configurable to perform a Check cycle on data stored in a first row of memory cells, where the Check cycle involves two or more read commands. The circuitry may be configurable to perform, after the Check cycle, a Scrub cycle to correct an error identified in the data.

### CROSS-REFERENCE TO RELATED APPLICATIONS

This application claims priority to U.S. Provisional Application No. 63/793,994, filed Apr. 24, 2025, which is incorporated by reference herein in its entirety.

### BACKGROUND

### Field of the Invention

Embodiments of the present disclosure relate generally to the field of semiconductor memory devices. More specifically, embodiments of the present disclosure relate to on-die error correction operations in a memory device.

### Description of the Related Art

The operational rate of memory devices, including the data rate of a memory device, has been increasing over time. As a side effect of the increase in speed of a memory device, data errors may become more problematic. For example, memory devices may be susceptible to voltage and/or temperature variations that may negatively impact signal integrity and/or data reliability especially in high-speed memory systems. To compensate for such errors, memory devices may use error correction circuitry to correct errors on-die. However, these error correction operations may negatively impact performance, such as by taking longer time than desired to perform.

### BRIEF DESCRIPTION OF THE DRAWINGS

Various aspects of this disclosure may better be understood upon reading the following detailed description and upon reference to the drawings in which:

FIG. 1 is a simplified block diagram illustrating certain features of a memory device that includes error correction code (ECC) circuitry that performs modified error check scrub (ECS) operations, according to an embodiment of the present disclosure;

FIG. 2 illustrates a block diagram of an example of the ECC circuitry of FIG. 1 that performs modified ECS operations, according to an embodiment of the present disclosure;

FIG. 3 is a flow diagram illustrating using the ECC circuitry of FIG. 2 to perform modified ECS operations based on using the memory of FIG. 2 to store the indications of identified errors, according to an embodiment of the present disclosure; and

FIG. 4 is a flow diagram illustrating using the ECC circuitry of FIG. 2 to perform modified ECS operations without using the memory of FIG. 2 to store the indications of identified errors, according to an embodiment of the present disclosure.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers’ specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

A memory device may perform Error Check and Scrub (ECS) operations to self-scrub its memory array to cure repairable errors or issues. ECS operations may involve performing a Read operation, a Modify operation, and a Write operation to one pre-fetch at a time. ECS operations may involve having time allocated to enable performing a Scrub cycle through the Modify Operation after each Read operation, which may take relatively large amounts of times to complete and may be unnecessary if data read in the Read operation is correct and error free.

As described herein, a modified ECS operation may be implemented in control circuitry of the memory device to perform on-die error correction that skips performing a Scrub cycle after each Read operation, waiting to perform the Scrub cycle after two or more Read operations. Doing so may process the memory array in less time than ECS operations that perform a Scrub cycle after each Check cycle.

To elaborate, the modified ECS operation may involve completing multiple ECS checks in a first cycle (e.g., in a back-to-back read based Identify operation) and, if an error is found, fixing the error in a second cycle (e.g., in a Fix operation). In doing so, the checking of memory cells to identify an error and fixing of the error may be temporally separated by one or more additional error checking cycles. Further, the memory array may be accessed using a column fast access operation (e.g., a column fast read operation), which may save additional activate and/or pre-charge time by performing two or more back-to-back reads and checking the resultant exclusive OR (XOR) output associated with the on-die error correction, enabling relatively faster overall processing times relative to other types of ECS operations. When the two or more back-to-back reads (e.g., in the Identify operation or Check cycle) lead to an error being discovered in the read data, a Scrub cycle may be planned to correct the errors in memory cells storing the read data having the error associated with the Fix operation. For example, the two or more back-to-back reads may indicate one error, which would cause control circuitry to schedule one Scrub cycle to remedy the one error, such as generally control circuitry performing an Identify operation, a Fix operation, followed by a subsequent Identify operation. For example, the two or more back-to-back reads may indicate two errors, which would cause control circuitry to schedule two Scrub cycles to remedy the two errors, such as generally control circuitry performing an Identify operation, a Fix operation, a Fix operation, followed by a subsequent Identify operation. When the two or more back-to-back reads do not lead to an error being discovered in the read data, the ECS operation may continue to process through the memory array without allocating time for the Scrub cycle. For example, the two or more back-to-back reads may indicate zero errors, which would cause control circuitry to skip scheduling any Scrub cycles as there are no errors to remedy, such as generally the control circuitry performing an Identify operation, followed by a subsequent Identify operation. Doing so may process the memory array in less time than ECS operations that perform a Scrub cycle (or allocated time to perform a Scrub cycle) after each Check cycle.

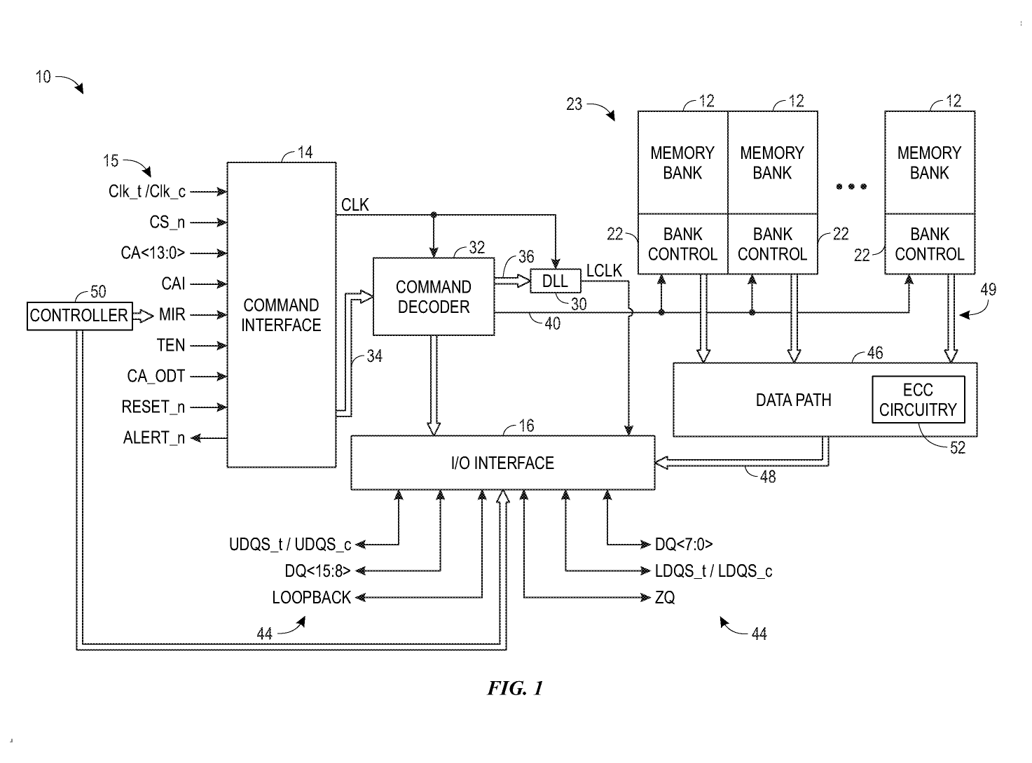

Turning now to the figures, FIG. 1 is a simplified block diagram illustrating certain features of a memory device 10. Specifically, the block diagram of FIG. 1 is a functional block diagram illustrating certain functionality of the memory device 10. In accordance with one embodiment, the memory device 10 may be a double data rate type four (DDR4 SDRAM), a double data rate type five synchronous dynamic random-access memory (DDR5 SDRAM) device, a low-power double data rate type four (LPDDR4 SDRAM), a low-power double data rate type five (LPDDR5 SDRAM), and/or another new type, such as double data rate type six (DDR6 SDRAM). Various features of DDR SDRAM devices allow for reduced power consumption, more bandwidth and more storage capacity compared to prior generations of DDR SDRAM.

The memory device 10 may include a number of memory banks 12. The memory banks 12 may be DDR6 SDRAM memory banks, for instance. The memory banks 12 may be provided on one or more chips (e.g., SDRAM chips) that are arranged on dual inline memory modules (DIMMS). Each DIMM may include a number of SDRAM memory chips (e.g., x8 or x16 memory chips), as will be appreciated. Each SDRAM memory chip may include one or more memory banks 12. The memory device 10 represents a portion of a single memory chip (e.g., SDRAM chip) having a number of memory banks 12. For DDR, the memory banks 12 may be further arranged to form bank groups. For instance, for an 8 gigabyte (Gb) DDR5 SDRAM, the memory chip may include 16 memory banks 12, arranged into 8 bank groups, each bank group including 2 memory banks. For a 16 Gb DDR5 SDRAM, the memory chip may include 32 memory banks 12, arranged into 8 bank groups, each bank group including 4 memory banks, for instance. Various other configurations, organization, and sizes of the memory banks 12 on the memory device 10 may be utilized depending on the application and design of the overall system.

The memory device 10 may include a command interface 14 and an input/output (I/O) interface 16 configured to exchange (e.g., receive and transmit) signals with external devices. The command interface 14 is configured to provide a number of signals (e.g., signals 15) from an external device (not shown), such as a processor or controller. The processor or controller may provide various signals 15 to the memory device 10 to facilitate the transmission and receipt of data to be written to or read from the memory device 10.

As will be appreciated, the command interface 14 may include a number of circuits, such as a clock input circuit 18 and a command address input circuit 20, for instance, to ensure proper handling of the signals 15. The command interface 14 may receive one or more clock signals from an external device. Generally, double data rate (DDR) memory utilizes a differential pair of system clock signals, referred to herein as the true clock signal (Clk_t) and the complementary clock signal (Clk_c). The positive clock edge for DDR refers to the point where the rising true clock signal Clk_t crosses the falling complementary clock signal Clk_c, while the negative clock edge indicates that transition of the falling true clock signal Clk_t and the rising of the complementary clock signal Clk_c. Commands (e.g., Read command, Write command, etc.) are typically entered on the positive edges of the clock signal and data is transmitted or received on both the positive and negative clock edges.

The clock input circuit 18 receives the true clock signal (Clk_t) and the complementary clock signal (Clk_c) and generates an internal clock signal CLK. The internal clock signal CLK is supplied to an internal clock generator 30, such as a delay locked loop (DLL) circuit. The internal clock generator 30 generates a phase controlled internal clock signal LCLK based on the received internal clock signal CLK. The phase controlled internal clock signal LCLK is supplied to the I/O interface 16, for instance, and is used as a timing signal for determining an output timing of read data.

The internal clock signal CLK may also be provided to various other components within the memory device 10 and may be used to generate various additional internal clock signals. For instance, the internal clock signal CLK may be provided to a command decoder 32. The command decoder 32 may receive command signals from a command bus 34 and may decode the command signals to provide various internal commands. For instance, the command decoder 32 may provide command signals to the internal clock generator 30 over the bus 36 to coordinate generation of the phase controlled internal clock signal LCLK. The phase controlled internal clock signal LCLK may be used to clock data through the I/O interface 16, for instance.

Further, the command decoder 32 may decode commands, such as Read commands, Write commands, mode-register set commands, Activate commands, etc., and provide access to a particular memory bank 12 corresponding to the command, via a data path 40. As will be appreciated, the memory device 10 may include various other decoders, such as row decoders and column decoders, to facilitate access to the memory banks 12. In one embodiment, each memory bank 12 includes a bank control block 22 which provides the necessary decoding (e.g., row decoder and column decoder), as well as other features, such as timing control and data control, to facilitate the execution of commands to and from the memory banks 12. Collectively, the memory banks 12 and the bank control blocks 22 may be referred to as a memory array 23. The memory array 23 may include, in each of the memory banks 12, multiple rows of memory cells spanning multiple columns of the rows.

The memory device 10 executes operations, such as Read commands and Write commands, based on the command/address signals received from an external device, such as a processor. In one embodiment, the command/address bus may be a 14-bit bus to accommodate the command/address signals (CA<13:0>). The command/address signals are clocked to the command interface 14 using the clock signals (Clk_t and Clk_c). The command interface may include a command address input circuit 20 which is configured to receive and transmit the commands to provide access to the memory banks 12, through the command decoder 32, for instance. In addition, the command interface 14 may receive a chip select signal (CS_n). The CS_n signal enables the memory device 10 to process commands on the incoming CA<13:0> bus. Access to specific memory banks 12 within the memory device 10 is encoded on the CA<13:0> bus with the commands.

In addition, the command interface 14 may be configured to receive a number of other command signals. For instance, a command/address on die termination (CA_ODT) signal may be provided to facilitate proper impedance matching within the memory device 10. A reset command (RESET_n) may be used to reset the command interface 14, status registers, state machines and the like, during power-up for instance. The command interface 14 may also receive a command/address invert (CAI) signal which may be provided to invert the state of command/address signals CA<13:0> on the command/address bus, for instance, depending on the command/address routing for the particular memory device 10. A mirror (MIR) signal may also be provided to facilitate a mirror function. The MIR signal may be used to multiplex signals so that they can be swapped for enabling certain routing of signals to the memory device 10, based on the configuration of multiple memory devices in a particular application. Various signals to facilitate testing of the memory device 10, such as the test enable (TEN) signal, may be provided, as well. For instance, the TEN signal may be used to place the memory device 10 into a test mode for connectivity testing.

The command interface 14 may also be used to provide an alert signal (ALERT_n) to the system processor or controller for certain errors that may be detected. For instance, an alert signal (ALERT_n) may be transmitted from the memory device 10 if a cyclic redundancy check (CRC) error is detected. Other alert signals may also be generated. Further, the bus and pin for transmitting the alert signal (ALERT_n) from the memory device 10 may be used as an input pin during certain operations, such as the connectivity test mode executed using the TEN signal, as described above.

Data may be sent to and from the memory device 10, utilizing the command and clocking signals discussed above, by transmitting and receiving data signals 44 through the I/O interface 16. More specifically, the data may be sent to or retrieved from the memory banks 12 over a data path 46, a data path 48, and/or data paths 49, which may include multiple bi-directional data connections. The data paths 46, 48, 49 may be busses. Data I/O signals, generally referred to as DQ signals, are generally transmitted and received in one or more bi-directional data connections. For certain memory devices, such as a DDR5 SDRAM memory device, the I/O signals may be divided into upper and lower bytes. For instance, for an x16 memory device, the I/O signals may be divided into upper and lower I/O signals (e.g., DQ<15:8> and DQ<7:0>) corresponding to upper and lower bytes of the data signals, for instance.

To allow for higher data rates within the memory device 10, certain memory devices, such as DDR memory devices may utilize data strobe signals, generally referred to as DQS signals. The DQS signals are driven by the external processor or controller sending the data (e.g., for a Write command) or by the memory device 10 (e.g., for a Read command). For Read commands, the DQS signals are effectively additional data output (DQ) signals with a predetermined pattern. For Write commands, the DQS signals are used as clock signals to capture the corresponding input data. As with the clock signals (Clk_t and Clk_c), the data strobe (DQS) signals may be provided as a differential pair of data strobe signals (DQS_t and DQS_c) to provide differential pair signaling during reads and writes. For certain memory devices, such as a DDR5 SDRAM memory device, the differential pairs of DQS signals may be divided into upper and lower data strobe signals (e.g., UDQS_t and UDQS_c; LDQS_t and LDQS_c) corresponding to upper and lower bytes of data sent to and from the memory device 10, for instance. In some embodiments as discussed below, the DQS may be internally generated from a clock received at the memory device 10 from the host device (not illustrated). In some such embodiments the DQS pins may be omitted from the memory device 10.

An impedance (ZQ) calibration signal may also be provided to the memory device 10 through the I/O interface 16. The ZQ calibration signal may be provided to a reference pin and used to tune output drivers and ODT values by adjusting pull-up and pull-down resistances of the memory device 10 across changes in process, voltage, and temperature (PVT) values. Because PVT characteristics may impact the ZQ resistor values, the ZQ calibration signal may be provided to the ZQ reference pin to be used to adjust the resistance to calibrate the input and output impedances to known values. A precision resistor may be coupled between the ZQ pin on the memory device 10 and GND/VSS external to the memory device 10. This resistor may act as a reference for adjusting internal ODT and drive strength of the IO pins.

In addition, a loopback signal (LOOPBACK) may be provided to the memory device 10 through the I/O interface 16. The loopback signal may be used during a test or debugging phase to set the memory device 10 into a mode wherein signals are looped back through the memory device 10 through the same pin. For instance, the loopback signal may be used to set the memory device 10 to test the data output of the memory device 10. Loopback may include both a data and a strobe or just a data pin. This is generally intended to be used to monitor the data captured by the memory device 10 at the I/O interface 16.

As will be appreciated, various other components such as power supply circuits (for receiving external VDD and VSS signals), mode registers (to define various modes of programmable operations and configurations), read/write amplifiers (to amplify signals during read/write operations), temperature sensors (for sensing temperatures of the memory device 10), etc., may also be incorporated into the memory device 10. Accordingly, it should be understood that the block diagram of FIG. 1 is provided to highlight certain functional features of the memory device 10 to aid in the subsequent detailed description.

The memory device 10 may be coupled to a memory controller 50. The memory controller 50 may include a processor, such as a central processing unit (CPU), a graphics processing unit (GPU), another microprocessor, a programmable logic device, and/or any other suitable processor that controls processing of system functions and requests. The memory controller 50 may be associated with a host device/processor that may itself include multiple processing units in addition to the memory controller 50.

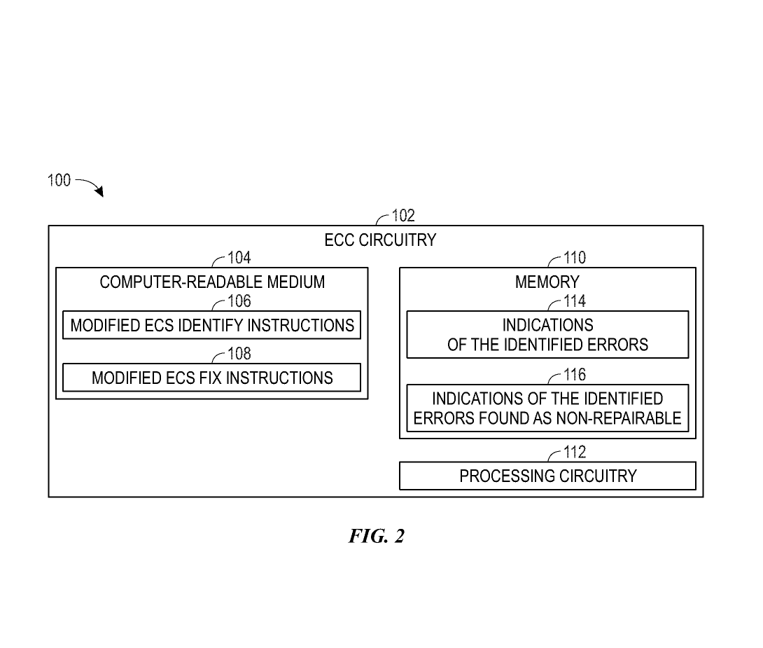

Memory devices, such as DDR5 DRAM devices, may include error-correcting code (ECC) circuitry 52 to perform on-die error detection and/or correction functions. The ECC circuitry 52 may be located in a location of the memory device 10 where data read from one or more memory banks 12 may undergo on-die error correction. For example, the ECC circuitry 52 may be located in data path 46, data path 48, or another suitable data path or in suitable circuitry of the memory device 10. As described further herein, the memory device 10, via the ECC circuitry 52, may use modified ECS operations to perform on-die error correction. The modified ECS operations may involve accessing a row and performing multiple reads (e.g., N-reads) with the single row accessed, which may save time by not individually accessing/precharging the row for each column. An example of the ECC circuitry 52 that uses the modified ECS operations is shown in FIG. 2.

FIG. 2 is a block diagram of an example memory device 10, memory device 100, that includes ECC circuitry 102 that uses modified ECS operations. The ECC circuitry 102 may be an example of the ECC circuitry 52 of FIG. 1.

The ECC circuitry 102 may include a tangible, non-transitory, computer-readable medium 104. The computer-readable medium 104 may store modified ECS Identify instructions 106 and modified ECS Fix instructions 108. The ECC circuitry 102 may also include a memory 110 (e.g., local memory) and processing circuitry 112. Any suitable memory may be used as the memory 110. For example, a content addressable medium (CAM) may be used as the memory 110. In some systems, a mode register or other suitable memory accessible by the memory controller 50, and thus by a host device, may be used. Any suitable processing circuitry may be used as the processing circuitry 112.

ECS operations may involve a fixed ECS cycle that performs read modify write operations for one memory cell at a time, where respective rows and columns may include hundreds or thousands of memory cells. For example, ECS operations may involve issuing an Activate (ACT) command, a Read command, a Modify command, a Write command, and a Precharge (PRE) command for each memory cell at each combination of row and column within the memory array. For example, the ECS operations may involve, for each memory cell, a time duration dedicated to reading prefetched data, a time duration dedicated to using parity to check if a correction is to be made on the prefetched data, a time duration dedicated to performing a correction (e.g., based on the Modify command), and a time duration dedicated to writing the modified or prefetched data back to the memory cell. These operations being performed one-by-one and with each operation having time allocated for performing the Modify command may cause ECS operations to take a relatively long amount of time to be performed over a full memory array, for example 24 hours. Indeed, if an error is not found in the read data from that memory cell located in that intersection of row and column, there may be no mechanism by which to skip the Modify command or to deallocate the time otherwise allocated for performing the Modify command.

Modified ECS operations may enable functionally skipping the Modify command until one or more errors at one or more memory cells are identified, which may enable deallocation of the time otherwise allocated for performing the Modify commands in cases where no error is found in the read data. For example, the modified ECS operations may involve, for each memory cell, a time duration dedicated to reading prefetched data, a time duration dedicated to using parity to check if a correction is to be made on the prefetched data, and a time duration dedicated to writing the modified or prefetched data back to the memory cell, where after one or more errors are identified for corrections may be time spent performing a correction (e.g., based on the Modify command). Doing so may enable Modify commands (e.g., Fix operations) to be batched, which may lead to more efficient use of time in memory operations and/or ECS operations occurring faster overall. For example, simulations of modified ECS operations show up to a 49.99% improvement when applied to 4K corrections with a 2-read Check cycle for a 16 Gb part, where even further time reductions may be expected with a greater-than-2-read-cycle system (e.g., N-reads is 3-reads, 4-reads, or the like). Furthermore, some systems may decide to not perform Modify commands—by decoupling the Modify command (e.g., Fix operations) from the Identify operations, a decision to not fix or a decision to delay fixing further (such as delaying on-die error correction to later perform a system-level error correction) may be enabled. For example, the system may decide not to perform Fix operations on errors pointing to known, unused Cayley values resulting from error identifying XOR operations. Performing the ECS operations in less time through modified ECS operations may provide the technical improvement of reducing power consumption in on-die error correction operations and/or of enabling additional time to be allocated to alternative memory operations than on-die error correction.

To elaborate further on the modified ECS operations, the processing circuitry 112 may execute the modified ECS Identify instructions 106 to cause the ECC circuitry 102 to perform Identify operations. Performing the Identify operations may involve the ECC circuitry 102 performing a Check cycle (e.g., Check cycle operations) on data stored in a respective row of a respective memory bank 12, repeated for each row of each memory bank 12. The Check cycle may involve at least generating multiple Read commands, such as to access data stored at memory cells at intersections of the respective row and multiple columns of that respective memory bank. Performing the Identify operations may involve the ECC circuitry 102 identifying an error in the data from the respective row processed via the Check cycle, such as by performing an error identifying XOR operation on the data, by performing operations based on Hamming code, or by performing another suitable error identification operation on the data. The processing circuitry 112 may execute the modified ECS Fix instructions 108 to cause the ECC circuitry 102 to perform Fix operations. The Fix operations may be temporally separated from the Identify operations. For example, the Fix operations may be temporally separated from the Identify operations by at least a duration of time allocated for the performance of two or more Read commands.

By executing the modified ECS Identify instructions 106, the processing circuitry 112 may cause the ECC circuitry 102 to activate a target row of a memory array, such as a respective row of a respective memory bank 12 of FIG. 1, to identify error(s) based on two or more read operations in two or more target columns of the activated target row (corresponding to a Check cycle) without repairing the errors, and to precharge the next target row to continue with identification operations of the memory array. In some cases, the processing circuitry 112 may cause the ECC circuitry 102 to store an indication of the identified error(s) in the memory 110 (e.g., the indications of identified errors 114) without repairing the errors.

By executing the modified ECS Fix instructions 108, the processing circuitry 112 may cause the ECC circuitry 102 to receive an indication of an identified error (either from the memory 110 or from the identification of the error directly), to determine whether the identified error is repairable, and to repair the identified error when repairable using on-die error correction methods (Scrub cycle), where repairs may be repeated for additional errors indicated in the memory 110 if used. The ECC circuitry 102 may generate a notification that ECS is complete once each row and each column of the memory array has undergone ECS. The notification may be transmitted to the memory controller 50 of FIG. 1. In some cases, by executing the modified ECS Fix instructions 108, the processing circuitry 112 may determine whether the identified error is repairable and may store an indication in the memory 110 when the identified error is not repairable. When the identified error in data is not repairable, the ECC circuitry 102 may generate an indication that the error is not repairable without performing the Scrub cycle operations on the data. The ECC circuitry 102 may store the indication of the identified errors found as non-repairable as indications 116 in memory 110. The indication 116 may later be read or received by the memory controller 50, which may trigger system-level error correction operations to attempt correction of these non-repairable errors (that is, non-repairable relative to die-level error correction operations). For example, an error may not be repairable if it does not point to a used Cayley value (meaning it points to an unused Cayley value). It is noted that attempting to repair these types of errors (e.g., an error pointing to an unused Cayley value) may cause multi-column bit flips to occur in a row, undesirably exasperating the error from a single bit error into a multi-bit error, and thus avoiding fixing these types of errors through on-die error correction operations may be desirable.

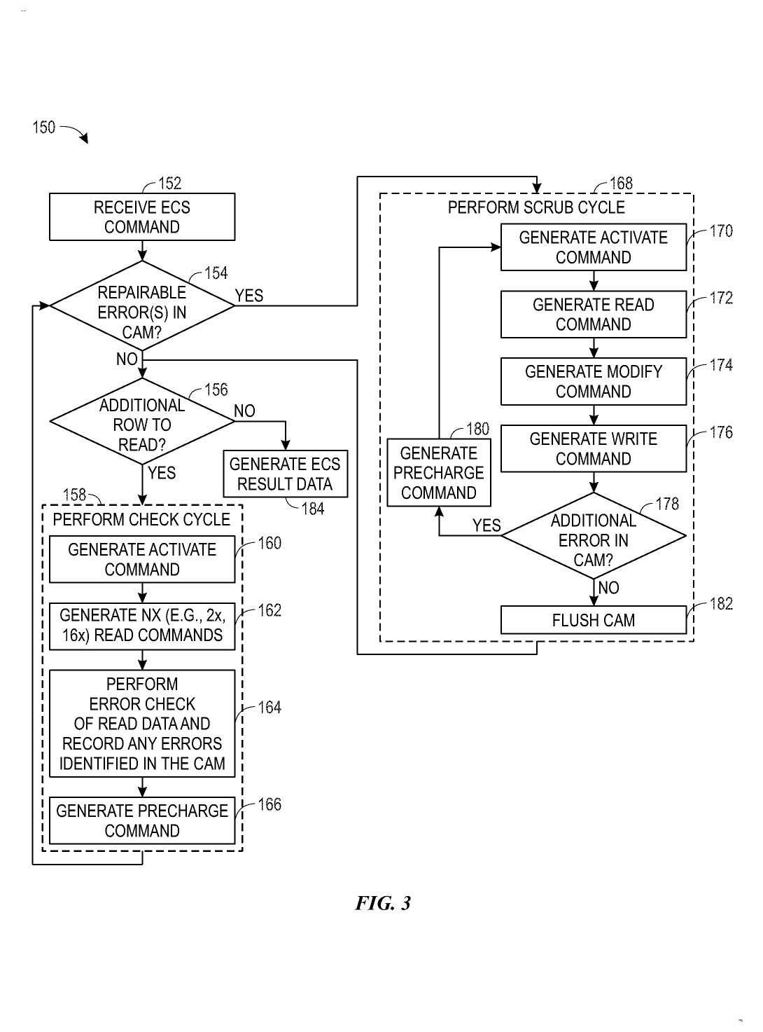

With the foregoing in mind, FIG. 3 is a flow diagram of a process 150 for using the ECC circuitry 102 to perform modified ECS operations based on using the memory 110 to store the indications of identified errors 114. As described herein, operations of the process 150 are performed via the ECC circuitry 102. However, it should be understood that processing circuitry, such as processing circuitry 112 of FIG. 2, may execute instructions stored in memory, like computer-readable medium 104, and when executed, to cause the ECC circuitry 102 to perform operations of the process 150. In some systems, the ECC circuitry 102 may be configurable hardware that through combinational logic may perform one or more operations of the process 150. Other suitable circuitry may be used to perform the operations of the process 150 relative to the memory array of the memory device 10, such as relative to the one or more memory banks 12 of FIG. 1.

At block 152, the ECC circuitry 102 may receive an ECS command. The memory controller 50 and/or the host device (not illustrated in FIG. 1) may generate the ECS command and transmit the ECS command to the memory device 10, such as at the command interface 14. The ECS command may instruct the memory device 10 to undergo on-die error correction operations.

At block 154, the ECC circuitry 102 may determine whether the memory 110 (e.g., a content addressable memory (CAM), or other suitable memory like a local memory) indicates any errors to undergo correction. As is discussed further herein relative to operations of block 160, the ECC circuitry 102 may record indications of errors identified through a Check cycle (e.g., Identify operation) in the memory 110, which may be read at a later time relative to operations of block 154.

When the memory 110 is empty (e.g., indicating no errors found so far), the ECC circuitry 102 may proceed with the operations of process 150. At block 156, the ECC circuitry 102 may determine if the memory device 10 includes an additional memory row to read. The ECC circuitry 102 may read row counters and compare the row counter to a total number of memory rows of the memory device 10 to determine whether an additional memory row is to be read. Based on this, the ECC circuitry 102 may adjust an integer to target the next memory row.

When there is an additional memory row, the ECC circuitry 102 may perform, at block 158, a Check cycle relative to the additional memory row. The Check cycle may involve, at block 160, the ECC circuitry 102 generating an Activate (ACT) command, at block 162, generating Nx Read commands, at block 164, performing an error check of the read data, and, at block 166, generating a PRE command to target a subsequent next memory row. Indeed, at block 160, the ECC circuitry 102 may generate the ACT command to activate the targeted memory row.

At block 162, the ECC circuitry 102 may generate Nx Read commands. The ECC circuitry 102 may generate a Read command for each column of the memory row being read. The number of Read commands generated may be more than two Read commands. For example, the number of Read commands may equal 16. The number of Read commands generated may be any number up to a number of the maximum allowed ECS reads, which may be limited based on an ECS time specification threshold. Any suitable number of Read commands may be generated (e.g., 2x, 3x, 4x, 5x,...16x, and so on), and the number of Read commands may be programmed on a per-memory-device 10 basis during manufacturing based on calibration operations to tailor memory device 10 operations to target performance metrics.

At block 164, the ECC circuitry 102 may perform an error check of the read data obtained at block 162 in response to the Nx Read commands, and, if an error is discovered during the error cycle, the ECC circuitry 102 may record any error(s) identified in the memory 110. The ECC circuitry 102, at block 168, may perform operations of a Scrub cycle based on determining, at block 154, whether one or more errors were discovered during the Check cycle based on reading the memory 110. The ECC circuitry may perform the Scrub cycle operations based on determining the memory 110 indicates the error. The ECC circuitry 102 may write indications of the error identified to the memory 110. The memory 110 may be considered local memory of the ECC circuitry 102. In some cases, the memory 110 may have a threshold number of errors to store before performing error correction via a Scrub cycle. In these systems, the determination at block 154 may check whether the threshold number of errors are stored in the memory 110. In some systems, a threshold number of rows may be checked before determining whether errors are indicated in the memory 110, which may additionally or alternatively be performed in association with determinations of block 154. The memory 110, when a CAM, may be a column CAM with a threshold number of rows of 1 row. Thus, the ECC circuitry 102 may write, to the CAM, address data indicating a combination of a respective column number to identify the storage location having the error. The CAM may be a CAM with a threshold number of rows greater than 1 row. Thus, the ECC circuitry 102 may write, to the CAM, address data indicating a combination of a respective column number and a respective row number to identify the storage location having the error. In some cases, on-die error correction operations may span memory banks 12, and thus the ECC circuitry 102 may write, to the CAM, address data indicating a combination of memory bank 12, respective column number, and respective row number to identify the storage location having the error. In some cases, the ECC circuitry 102 may determine whether error(s) identified during the Check cycle are repairable and may store an indication in the memory 110 when the identified error is repairable. For example, an error may be repairable if it points to a used Cayley value or if it is an error spanning multiple bits in a subset of data.

At block 166, the ECC circuitry 102 may generate a PRE command to target a next memory row. The PRE command may cause the memory device 10 to prefetch data stored in memory cells of the next memory row. In some cases, the determination of the additional row to be read at block 156 may occur between block 164 and block 166, where if the target row of the Check cycle was a last row, the PRE command may not be generated at block 166.

Returning to block 154, the ECC circuitry 102 may determine whether the memory 110 indicates at least one repairable error and, if so, may proceed to perform a Scrub cycle at block 168. In some systems, the ECC circuitry 102 may store the indications in the memory 110 in response to the error being repairable through on-die error correction, and thus by way of reading the indications from the memory 110, the ECC circuitry 102 may deem the errors repairable and proceed with the Scrub cycle. In some systems, each error discovered during the check cycle operations is recorded in the memory 110 and thus the ECC circuitry 102 at block 154 may determine whether the error indicated by the memory 110 is repairable through on-die error corrections. In either case, when the ECC circuitry 102 deems the error repairable through on-die error corrections, the ECC circuitry 102 may perform the Scrub cycle at block 168.

Performing the Scrub cycle at block 168 may involve the ECC circuitry 102 generating an ACT command (block 170), generating a Read command (e.g., 1x Read command) (block 172), generating a Modify command (block 174), generating a Write command (block 176), and generating a precharge (PRE) command (block 180). At block 170, the ECC circuitry 102 may generate the ACT command. The ACT command may cause the memory device 10 to activate a memory row storing the data having the identified error. The memory 110 may store indications of the identified error as or with indications of its stored location (e.g., storage location) within the memory array, such as a combination of column and row numbers or just the column number (when a size of the memory 110 corresponds to a row length of 1 row). This information may be referenced by the ECC circuitry 102 when generating the ACT command at block 170.

At block 172, the ECC circuitry 102 may generate the Read command. The Read command may cause the memory device 10 to read a bit from the storage location indicated in the memory 110.

At block 174, the ECC circuitry 102 may generate a Modify command. The Modify command may cause the memory device 10 to flip a value of the bit of the read bit. The ECC circuitry 102 may not re-perform the error check operations of block 164 during the Scrub cycle of block 168 due to how the indications of errors read from the memory 110 at block 154 were previously identified as errors.

At block 176, the ECC circuitry 102 may generate a Write command. The Write command may cause the memory device 10 to write the modified bit from block 174 to the storage location.

At block 178, the ECC circuitry 102 may determine whether another error is indicated in the memory 110. When the memory 110 indicates another error, at block 180, the ECC circuitry 102 may generate the PRE command. The PRE command may be generated relative to an additional storage location indicated in the memory 110. The PRE command may cause the memory device 10 to prefetch a row storing data at the storage location.

When the memory 110 does not indicate another error, at block 182, the ECC circuitry 102 may flush the memory 110. Indeed, the ECC circuitry 102 may flush the CAM after the Scrub cycle operations. This may prepare the memory 110 for subsequent Check cycles to be performed relative to any additional memory rows to be read (based on determination at block 156), where the Check cycle operation may be performed for each column of multiple columns of each memory row.

Returning to block 154, the ECC circuitry 102 may determine whether the memory 110 indicates at least one repairable error and, if not, may proceed to determine whether there is an additional memory row to read at block 156. The Check cycle operations of block 158 and the Scrub cycle operations of block 168 may repeat until no further rows are to be processed. When this occurs, the ECC circuitry 102 may determine that no further memory rows are to be read at block 156 and proceed to block 184.

At block 184, the ECC circuitry 102 may generate ECS result data and/or may generate a notification. The ECS result data and/or the notification may indicate to the memory controller 50 that ECS operations have completed. In some cases, the ECS result data includes indications of which data in which memory cells were corrected. The ECS result data may be stored in a register accessible by the host device. The register may be considered a transparent register. The ECS result data may indicate which errors were not corrected. The memory controller 50 and/or host device may perform one or more operations based on the ECS result data, such as system-level error correction operation to attempt correction of the errors not corrected. By operating the ECC circuitry 102 based on operations of process 150, on-die error correction operations may take less time to complete as the Scrub cycle is selectively performed to fix errors without having time allocated to perform the Scrub cycle after each Check cycle.

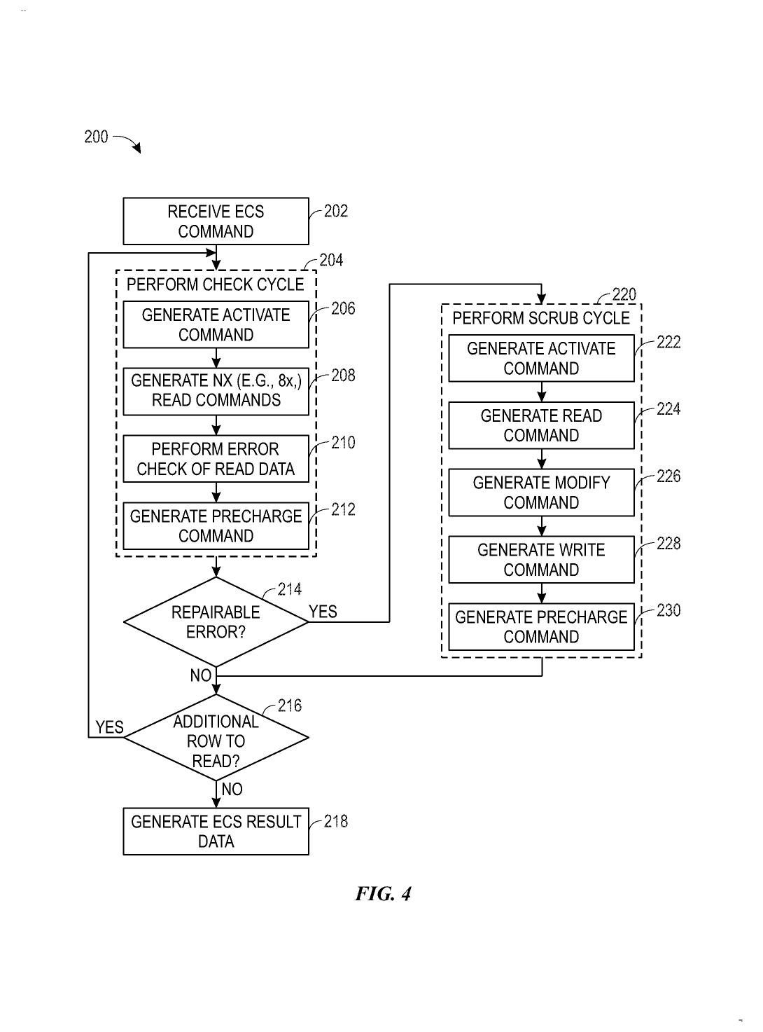

In some systems, the ECC circuitry 102 may not use a memory 110 (e.g., a CAM) to store the indications of errors. The memory 110 may not be used when relatively smaller footprints of ECC circuitry 102 are desired. FIG. 4 illustrates example on-die error correction operations that are not based on the memory 110.

FIG. 4 is a flow diagram of a process 200 for using the ECC circuitry 102 to perform modified ECS operations without using the memory 110 to store the indications of identified errors 114. As described herein, operations of the process 200 are performed via the ECC circuitry 102. However, it should be understood that processing circuitry, such as processing circuitry 112 of FIG. 2, may execute instructions stored in memory, like computer-readable medium 104, and when executed, to cause the ECC circuitry 102 to perform operations of the process 200. In some systems, the ECC circuitry 102 may be configurable hardware that through combinational logic may perform one or more operations of the process 200. Other suitable circuitry may be used to perform the operations of the process 200 relative to the memory array of the memory device 10, such as relative to the one or more memory banks 12 of FIG. 1.

At block 202, the ECC circuitry 102 may receive an ECS command. The ECS command may be received from the memory controller 50 and/or the host device (not illustrated in FIG. 1). The ECS command may instruct the memory device 10 to undergo on-die error correction operations. Execution priority of the ECS command may be based on when the ECS command is issued.

At block 204, the ECC circuitry 102 may perform a Check cycle relative to a memory row. The Check cycle may involve the ECC circuitry 102 generating an ACT command (block 206), generating Nx Read commands (block 208), performing an error check of the read data (block 210), and generating a PRE command to target a subsequent next memory row (block 212). Indeed, at block 206, the ECC circuitry 102 may generate the ACT command to activate the targeted memory row.

At block 208, the ECC circuitry 102 may generate Nx Read commands. The ECC circuitry 102 may generate a Read command for each column of the memory row being read. The number of Read commands generated may be more than two Read commands. For example, the number of Read commands may equal 8. The number of Read commands generated may be any number up to a number of the maximum allowed ECS reads, which may be limited based on an ECS time specification threshold. Any suitable number of Read commands may be generated (e.g., 2x, 3x, 4x, 5x,...8x, and so on), and the number of Read commands may be programmed on a per memory device basis during manufacturing based on calibration operations to tailor memory device 10 operations to target performance metrics.

At block 210, the ECC circuitry 102 may perform an error check of the read data obtained at block 208 in response to the Nx Read commands. To identify the error in the read data, the ECC circuitry 102 may perform an error identifying XOR operation on the data read from the target memory row, which may span multiple columns of data. If an error is discovered during the error cycle, the ECC circuitry 102 may proceed to perform a Scrub cycle at block 220 based on determinations at block 220.

At block 212, the ECC circuitry 102 may generate a PRE command to target a next memory row. The PRE command may cause the memory device 10 to prefetch data stored in memory cells of the next memory row. In some cases, the determination of the additional row to be read at block 216 may occur between block 210 and block 212, where if the target row of the Check cycle was a last row, the PRE command may not be generated at block 212.

At block 214, the ECC circuitry 102 determines whether the error is repairable. The ECC circuitry 102 may determine whether error(s) identified during the Check cycle are repairable and may perform the Scrub cycle in response to the error(s) being repairable through on-die error correction methods. For example, an error may be repairable if it points to a used Cayley value or if it is an error spanning multiple bits in a subset of data. The error check operations and the determination operations of whether error(s) identified are repairable may be based on the ECC circuitry 102 maintaining data in a local cache as opposed to writing the data to a memory 110 (e.g., operations of FIG. 3). The ECC circuitry 102 may discover an error, determine that the error is repairable, and proceed to perform the Scrub cycle without writing intermediate results to the memory 110. The ECC circuitry 102, in response to discovering the error, may retain data in a local cache of the storage location of data of the error such that, during the Scrub cycle, the data may be read from the storage location for on-die error correction.

When the ECC circuitry 102 determines that the error is not repairable, at block 216, the ECC circuitry 102 may determine if the memory device 10 includes an additional memory row to read. The ECC circuitry 102 may read row counters and compare the row counter to a total number of memory rows of the memory device 10 to determine whether an additional memory row is to be read. Based on this, the ECC circuitry 102 may adjust an integer to target the next memory row and proceed with an additional Check cycle (at block 204) for the next targeted memory row. This may continue until the ECC circuitry 102 performs the Check cycle on each memory row based on determining that no further memory rows are to be processed at block 216, proceeding to block 218.

At block 218, the ECC circuitry 102 may generate ECS result data and/or may generate a notification. The ECS result data and/or the notification may indicate to the memory controller 50 that ECS operations have completed. In some cases, the ECS result data includes indications of which data in which memory cells were corrected by the ECC circuitry 102. The ECC circuitry 102 may write the ECS result data in a register accessible by the host device. The register may be considered a transparent register. The ECS result data may indicate which errors were not corrected. The memory controller 50 and/or host device may perform one or more operations based on the ECS result data, such as system-level error correction operation to attempt correction of the errors not corrected.

Referring back to block 214, the ECC circuitry 102 may determine that the error is repairable and may proceed to perform a Scrub cycle at block 220. At block 220, the ECC circuitry 102 may perform operations of a Scrub cycle based on determining, at block 214, whether one or more errors were discovered during the Check cycle (e.g., based on performing the error check at block 210). The Scrub cycle operations may include generating an ACT command (block 222), generating a Read command (block 224), generating a Modify command (block 226), generating a Write command (block 228), and generating a PRE command (block 230) when an additional error is to be corrected from the error(s) identified via the Check cycle (e.g., at block 210).

At block 222, the ECC circuitry 102 may generate the ACT command. The ACT command may cause the memory device 10 to activate a memory row storing the data having the identified error. The generated ACT command may target the storage location of the error (e.g., a first error) identified via the Check cycle (e.g., at block 210).

At block 224, the ECC circuitry 102 may generate the Read command. The Read command may cause the memory device 10 to read a bit from the storage location of the error.

At block 226, the ECC circuitry 102 may generate a Modify command. The Modify command may cause the memory device 10 to flip a value of the bit of the read bit. The ECC circuitry 102 may not re-perform the error check operations of block 210 during the Scrub cycle of block 220 due to how errors were previously identified via the Check cycle (e.g., at block 210).

At block 228, the ECC circuitry 102 may generate a Write command. The Write command may cause the memory device 10 to write the modified bit from block 226 to the storage location.

At block 230, the ECC circuitry 102 may generate the PRE command. If multiple repairable errors are identified, the Scrub cycle may be repeated for each error and respective PRE commands generated at each iteration of the Scrub cycle at block 230. An additionally generated PRE command may target additional storage locations of the other identified repairable errors. The PRE command may cause the memory device 10 to prefetch a row storing data at the storage location. By operating the ECC circuitry 102 based on operations of process 200, on-die error correction operations may take less time to complete as the Scrub cycle is selectively performed to fix errors without having time allocated to perform the Scrub cycle after each Check cycle.

It is noted that the ECC circuitry 102 may schedule performance of one or more Check cycles and/or one or more Scrub cycles as part of the operations described herein, such as at block 214 in determining that the one or more identified errors are repairable or at block 154 in determining that the CAM indicates one or more identified errors are repairable. To schedule Check cycles and/or Scrub cycles, the ECC circuitry 102 may reference timing parameters in memory, which may indicate a ECS interval to follow (t_{ECSint} ). The ECS interval may correspond to a number of Check cycles associated with performing a full ECS operation relative to the memory device 10, a target time within which to perform the full ECS operation (e.g., such as 18 hours, 24 hours, 36 hours, 1 week, or the like), and/or a number of manual ECS operations to complete the full ECS operation relative to the memory device 10, which may correspond to a number of code words of the memory array 23. The target time within which to perform the full ECS operation may include time during which to perform a designated or expected number of Fix operations, may represent time during which to perform each Identify operation, or a combination of the two operations, or the like. For the memory device 10 to perform automated ECS operations, such as while operating in an automated ECS mode, the host device, via memory controller 50, may issue at periodic intervals refresh commands. The memory device 10 in the automated ECS mode may perform the modified ECS operations automatically without further commands being received from the memory controller 50 beyond the initiating ECS command, such as the command of block 152 or block 202. An example of the ECS command may be the refresh command from the memory controller 50. The modified ECS operations may be timed by the memory device 10, via the ECC circuitry 102, to complete within the periodic interval between refresh commands. The periodic interval between refresh commands may be an example of the target time within which to perform the full ECS operation. Any registers (e.g., transparency registers) may be updated during this time for host device access to data related to the automated ECS operations.

Systems and methods described herein may enable modified ECS operations that skip a Modify command until one or more errors at one or more memory cells are identified, which may enable deallocation of the time otherwise allocated for performing the Modify commands in cases where no error is found in the read data. Doing so may enable Modify commands (e.g., Fix operations) to be batched, which may lead to more efficient use of time in memory operations and/or ECS operations occurring faster overall. Furthermore, some systems may decide to not perform Modify commands—by decoupling the Modify command (e.g., Fix operations) from the Identify operations, a decision to not fix or a decision to delay fixing further or to not fix may be enabled. Performing the ECS operations in less time through modified ECS operations may provide the technical improvement of reducing power consumption in on-die error correction operations and/or enabling additional time to be allocated to alternative memory operations than the instructed ECS operation. Examples of alternative memory operations include row hammer operations, other targeted ECS operations, additional refresh operations, and the like.

While the present disclosure may be susceptible to various modifications and alternative forms, specific embodiments have been shown by way of example in the drawings and have been described in detail herein. However, it should be understood that the present disclosure is not intended to be limited to the particular forms disclosed. Rather, the present disclosure is intended to cover all modifications, equivalents, and alternatives falling within the spirit and scope of the present disclosure as defined by the following appended claims.

The techniques presented and claimed herein are referenced and applied to material objects and concrete examples of a practical nature that demonstrably improve the present technical field and, as such, are not abstract, intangible, or purely theoretical. Further, if any claims appended to the end of this specification contain one or more elements designated as “means for [perform]ing [a function]…” or “step for [perform]ing [a function]…,” it is intended that such elements are to be interpreted under 35 U.S.C. 112(f). However, for any claims containing elements designated in any other manner, it is intended that such elements are not to be interpreted under 35 U.S.C. 112(f).

What is claimed is:

1. A system, comprising:
a memory bank comprising a first row of memory cells spanning a plurality of columns; and
circuitry configured to:
perform a check cycle operation on data stored in the first row at the plurality of columns at least in part by generating a plurality of read commands to access the data at the plurality of columns;
identify an error in the data stored in the first row based on the check cycle operation; and
perform a scrub cycle operation configured to correct the error in the data.

2. The system of claim 1, wherein the circuitry is configured to identify the error in the data based on performing an error identifying XOR operation on the data read from the first row spanning the plurality of columns.

3. The system of claim 1, wherein the circuitry is configured to:
determine that the error is repairable; and
perform the scrub cycle operation based on determining that the error is repairable.

4. The system of claim 1, wherein the memory bank comprises a second row of memory cells spanning the plurality of columns, wherein the circuitry is configured to:
activate the second row of memory cells;
perform the check cycle operation on additional data stored in the second row of memory cells at the plurality of columns at least in part by generating an additional plurality of read commands;
identify an error in the additional data stored in the second row based on the check cycle operation;
determine that the error in the additional data is not repairable; and
generate an indication that the error in the additional data is not repairable without performing the scrub cycle operation on the additional data.

5. The system of claim 1, wherein the circuitry comprises local memory, and wherein the circuitry is configured to perform the scrub cycle operation based on determining that local memory indicates the error.

6. The system of claim 5, wherein the local memory comprises a content addressable memory configured to store an indication that the error in the data was identified at a respective column of the plurality of columns.

7. The system of claim 6, wherein the circuitry is configured to flush the content addressable memory after the scrub cycle operation, wherein the check cycle operation is configured to be performed for each column of the plurality of columns.

8. The system of claim 5, wherein the local memory comprises a content addressable memory configured to store an indication that the error in the data was identified at a respective column of the plurality of columns and in the first row.

9. The system of claim 8, wherein the memory bank comprises a second row of memory cells spanning the plurality of columns, wherein the circuitry is configured to flush the content addressable memory after the scrub cycle operation, wherein the check cycle operation is configured to be performed for each column of the plurality of columns, for the first row, and for the second row.

10. A tangible, non-transitory, computer-readable medium comprising instructions that, when executed by processing circuitry, cause the processing circuitry to perform operations comprising:
performing a check cycle operation on data stored in a first row of memory cells at a plurality of columns at least in part by generating a plurality of read commands to access the data at the plurality of columns;
identifying an error in the data stored in the first row based on the check cycle operation; and
performing a scrub cycle operation configured to correct the error in the data.

11. The tangible, non-transitory, computer-readable medium of claim 10, wherein performing the check cycle operation comprises:
generating a plurality of read commands; and
generating a precharge command after generating the plurality of read commands.

12. The tangible, non-transitory, computer-readable medium of claim 10, wherein performing the scrub cycle operation comprises:
reading, from a content addressable memory, an indication of a memory cell storing data associated with the error after the check cycle operation;
generating an activate command to access a row comprising the memory cell;
generating a read command to read the data from the memory cell;
generating a modify command to modify the data;
generating a write command to write the data to the memory cell; and
flushing the content addressable memory after generating the write command.

13. The tangible, non-transitory, computer-readable medium of claim 12, wherein reading the indication of the memory cell comprises reading, from the content addressable memory, an indication that the error in the data was identified at a respective column of the plurality of columns.

14. The tangible, non-transitory, computer-readable medium of claim 12, wherein reading the indication of the memory cell comprises reading, from the content addressable memory, an indication that the error in the data was identified at a respective column of the plurality of columns and in the first row.

15. A system, comprising:
a memory bank comprising a first row of memory cells spanning a plurality of columns; and
circuitry configured to:
perform a check cycle operation on data stored in the first row of memory cells spanning two or more columns of the plurality of columns; and
after the check cycle operation, perform a scrub cycle operation configured to correct an error in the data.

16. The system of claim 15, wherein the circuitry comprises local memory, and wherein the circuitry is configured to perform the scrub cycle operation based on determining that local memory indicates the error.

17. The system of claim 16, wherein the local memory comprises a content addressable memory configured to store an indication that the error in the data was identified at a respective column of the two or more columns.

18. The system of claim 17, wherein the circuitry is configured to flush the content addressable memory after the scrub cycle operation, wherein the check cycle operation is configured to be performed for each column of the plurality of columns.

19. The system of claim 16, wherein the local memory comprises a content addressable memory configured to store an indication that the error in the data was identified at a respective column of the two or more columns and in the first row.

20. The system of claim 19, wherein the memory bank comprises a second row of memory cells spanning the plurality of columns, wherein the circuitry is configured to flush the content addressable memory after the scrub cycle operation, wherein the check cycle operation is configured to be performed for each column of the plurality of columns, for the first row, and for the second row.
